(19) United States
(12) Patent Application Publication
(10) Pub. No.: US 2023/0320552 A1
(43) Pub. Date: Oct. 12, 2023

(54) METHOD AND APPARATUS FOR CONTROLLING MOVEMENT OF SWEEPING ROBOT, AND SWEEPING ROBOT

(71) Applicants: GREE ELECTRIC APPLIANCES, INC. OF ZHUHAI, Zhuhai (CN); ZHUHAI LEAYUN TECHNOLOGY CO. LTD, Zhuhai (CN)

(72) Inventors: Yanyu CHEN, Zhuhai (CN); Xinlei MA, Zhuhai (CN); Yaqi MA, Zhuhai (CN); Linhui XU, Zhuhai (CN); Jianfeng DENG, Zhuhai (CN); Jinwen DING, Zhuhai (CN)

(21) Appl. No.: 18/042,286

(22) PCT Filed: Aug. 13, 2021
(86) PCT No.: PCT/CN2021/112600

§ 371 Date: Feb. 20, 2023

(30) Foreign Application Priority Data
Oct. 15, 2020 (CN) 202011104515.8

(51) Int. Cl. A47L 11/40; A47L 11/24

(52) U.S. Cl. CPC A47L 11/4011; A47L 11/24; A47L 11/4036; A47L 2201/04

(57) ABSTRACT

Provided are a method and apparatus for controlling movement of a sweeping robot, and the sweeping robot. At least one position of at least one cleaning side brush at a bottom of the sweeping robot is distributed on the basis of a Reuleaux triangle. The method includes the following steps: if it is detected that the sweeping robot is currently in a corner environment, determining a central movement trajectory of the sweeping robot according to the corner environment, wherein the central movement trajectory of the sweeping robot is consistent with that of the Reuleaux triangle (S302); and controlling the sweeping robot to move according to the central corner environment trajectory of the sweeping robot, and at the same time controlling the sweeping robot to rotate on its axis, such that the cleaning side brushes clean the corner environment (S304).

### CROSS-REFERENCE TO RELATED APPLICATION

The present disclosure is a National Stage Entry of International Patent Application No. PCT/CN2021/112600, entitled “Method and apparatus for controlling movement of sweeping robot, and sweeping robot,” filed Aug. 13, 2021, which claims the priority of Chinese patent application No. 202011104515.8, entitled “Method and apparatus for controlling movement of sweeping robot and sweeping robot”, filed in China Patent Office on Oct. 15, 2020, the entire contents of which are incorporated into this disclosure by reference.

### TECHNICAL FIELD

The present disclosure belongs to the technical field of control, and particularly relates to a method and apparatus for controlling movement of a sweeping robot, and the sweeping robot.

### BACKGROUND

More and more families use sweeping robots to clean the floors. A home environment is usually complicated due to the existence of furniture such as chairs, tables and sofas. If the sweeping robot is D-shaped or square, although it can clean a right-angled area, a square tail is prone to scratching the furniture when it rotates, and is easily stuck when it turns in a narrow area. In order to adapt to a cleaning task in the home environment and avoid unnecessary collision due to corners of the robot, most of the existing sweeping robots are round. However, due to the shape characteristics of the circular sweeping robot itself, it is difficult to sweep corner areas in the home environment such as a wall corner, leading to cleaning blind areas.

### SUMMARY

In order to at least overcome the problems existing in the related arts to a certain extent, the present disclosure provides a method and apparatus for controlling movement of the sweeping robot, and the sweeping robot, so that the circular sweeping robot can clean corner areas, thereby effectively reducing the cleaning blind areas.

To achieve the above purposes, the present disclosure adopts the following technical solution.

In a first aspect, the present disclosure provides a method for controlling movement of a sweeping robot, in which at least one position of at least one cleaning side brush at a bottom of the sweeping robot is distributed on the basis of a Reuleaux triangle, the method comprising: if it is detected that the sweeping robot is currently in a corner environment, determining a central movement trajectory of the sweeping robot according to the corner environment, wherein the central movement trajectory of the sweeping robot is consistent with that of the Reuleaux triangle; and controlling the sweeping robot to move according to the central movement trajectory of the sweeping robot, and at the same time controlling the sweeping robot to rotate on its axis, such that the cleaning side brushes clean the corner environment.

In some implementations, the number of the cleaning side brush is one, two or three, and each of the cleaning side brush is arranged at a vertex of the Reuleaux triangle.

In some implementations, the method further comprises: collecting environmental information of the sweeping robot, and judging whether the environmental information contains a corner feature; if the environmental information contains the corner feature, determining that the sweeping robot is currently in the corner environment.

In some implementations, the step of determining the central movement trajectory of the sweeping robot according to the corner environment comprises determining the central movement trajectory of the sweeping robot based on a SLAM technology and the corner environment.

In some implementations, the step of controlling the sweeping robot to move according to the central movement trajectory of the sweeping robot comprises: detecting a real-time movement state of the sweeping robot; performing trajectory tracking control on the sweeping robot according to the real-time movement state and the central movement trajectory of the sweeping robot, so as to ensure that the sweeping robot moves according to the central movement trajectory of the sweeping robot.

In some implementations, the corner environment includes a right-angled environment.

In some implementations, when the sweeping robot moves according to the central movement trajectory of the sweeping robot and rotates on its axis, a coverage of the cleaning side brush in the sweeping process is a square coverage.

In the second aspect, the present disclosure provides an apparatus for controlling movement of a sweeping robot, in which at least one position of at least one cleaning side brush at a bottom of the sweeping robot is distributed on the basis of a Reuleaux triangle, the apparatus comprising: a trajectory determination module, configured to determine a central movement trajectory of the sweeping robot according to a corner environment if it is detected that the sweeping robot is currently in the corner environment, wherein the central movement trajectory of the sweeping robot is consistent with that of the Reuleaux triangle; and a movement control module, configured to control the sweeping robot to move according to the central movement trajectory of the sweeping robot, and at the same time control the sweeping robot to rotate on its axis to use, such that the cleaning side brushes clean the corner environment.

In a third aspect, the present disclosure provides a sweeping robot, in which at least one position of at least one cleaning side brushes at a bottom of the sweeping robot is distributed on the basis of a Reuleaux triangle, the sweeping robot comprising: a processor and a storage apparatus, wherein the storage apparatus has stored thereon a computer program, which, when run by the processor, executes the method according to any one of the first aspect.

In a fourth aspect, the present disclosure provides a storage medium having stored thereon a computer program, which, when run by a processor, executes the steps of the method according to any one of the first aspect described above.

According to the method and apparatus for controlling the movement of the sweeping robot and the sweeping robot disclosed by the present disclosure, at least one position of the at least one cleaning side brush at the bottom of the sweeping robot is distributed on the basis of the Reuleaux triangle, and if it is detected that the sweeping robot is currently in the corner environment, the central movement trajectory of the sweeping robot (which is consistent with the central movement trajectory of the Reuleaux triangle) is determined according to the corner environment; then the sweeping robot is controlled to move according to the central movement trajectory of the sweeping robot, and the sweeping robot is also controlled to rotate on its axis, such that the cleaning edge brushes can clean the corner environment. In this way, the circular sweeping robot can clean the corner environment such as a right-angled area by utilizing the trajectory characteristics of the Reuleaux triangle, which can effectively reduce cleaning blind areas.

It should be understood that both the foregoing general description and the following detailed description are exemplary and explanatory only and do not limit the present disclosure.

### BRIEF DESCRIPTION OF THE DRAWINGS

In order to more clearly explain the embodiments of the present disclosure or the technical solutions in related arts, the drawings used in the embodiments or the description of the related art will be briefly introduced below. Obviously, the drawings in the following description are only some embodiments of the present disclosure, and other drawings can be obtained according to these drawings without creative labor.

FIG. 1 is a schematic diagram illustrating the generation of a Reuleaux triangle according to an exemplary embodiment;

FIG. 2 is a schematic diagram illustrating a generation direction trajectory of a Reuleaux triangle according to an exemplary embodiment;

FIG. 3 is a flowchart illustrating a method for controlling movement of a sweeping robot according to an exemplary embodiment;

FIG. 4 is a flowchart illustrating a method for controlling movement of a sweeping robot according to an exemplary embodiment;

FIG. 5 is a schematic diagram illustrating a main structure of a sweeping robot according to an exemplary embodiment;

FIG. 6 is a structural block diagram illustrating an apparatus for controlling movement of a sweeping robot according to an exemplary embodiment.

### DETAILED DESCRIPTION OF THE EMBODIMENTS

In order to make the purposes, technical solutions and advantages of the present disclosure clearer, the technical solution of the present disclosure will be described in detail below. Apparently, the described embodiments are merely some, but not all, of the embodiments of the present disclosure. Based on the embodiments in the present disclosure, all other implementations obtained by those of ordinary skill in the art without creative labor are within the scope of protection of the present disclosure.

Considering that circular sweeping robots in related arts basically have the problem of missing sweeping wall corners, the embodiments of the present disclosure provide a method and apparatus for controlling movement of a sweeping robot, and the sweeping robot, so that the circular sweeping robots can clean corner areas by utilizing the characteristics of the movement trajectory of the Reuleaux triangle, thus effectively reducing the cleaning blind areas. For ease of understanding, the embodiments of the present disclosure are described in detail below.

First of all, an embodiment of the present disclosure provides a sweeping robot, which can have a circular structure, wherein at least one position of at least one cleaning side brush at a bottom of the sweeping robot is distributed on the basis of the Reuleaux triangle. In a practical application, the side brush can be distributed based on a dust suction port and driving habits, the number of the cleaning side brush can be one, two or three, and each cleaning side brush is arranged at a vertex of the Reuleaux triangle. That is, when the number of the cleaning side brush is one, it can be arranged at any vertex of the Reuleaux triangle, when the number of the cleaning side brush is two, it can be arranged at any two vertices of the Reuleaux triangle, and when the number of the cleaning side brush is three, one cleaning side brush is arranged at each vertex of the Reuleaux triangle.

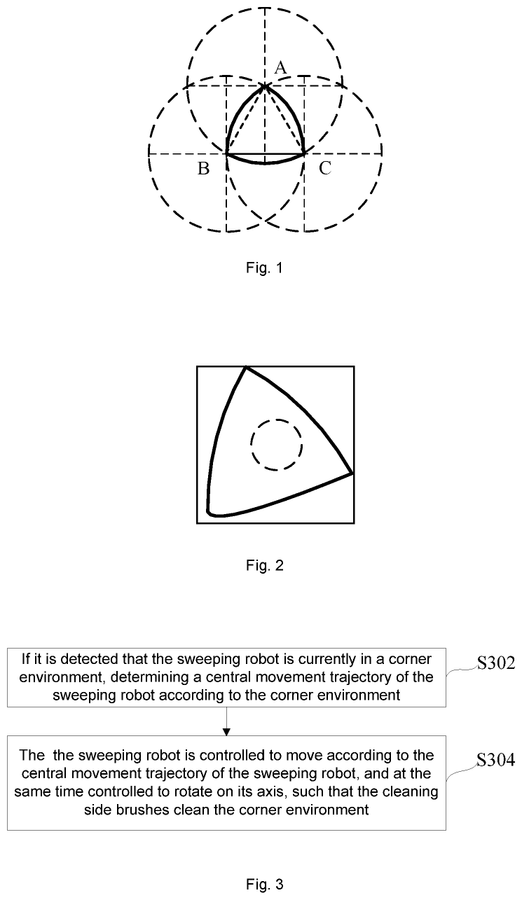

For ease of understanding, the Reuleaux triangle will be first described below. The Reuleaux triangle, which can also be called a circular arc triangle, is a special triangle. As shown in FIG. 1, by taking vertexes ABC of a regular triangle as centers of circles respectively and a side length of the regular triangle as a radius of each circle, three circular arcs (solid lines in FIG. 1) are drawn, forming a curved line triangle, which is the Reuleaux triangle. The characteristic of the Reuleaux triangle is that it has the same width in all directions, that is, it can rotate freely between two parallel lines whose distance is equal to its arc radius (equal to the side length of the regular triangle), and always keep in contact with the two straight lines. As shown in FIG. 2, a center point of the Reuleaux triangle moves according to a certain trajectory (a circular trajectory with a specific radius symbolically indicated by the dotted line in FIG. 2), and the Reuleaux triangle rotates according to the movement trajectory of its center point, which can envelope a square trajectory, that is, a coverage can form a square coverage. The applicant utilizes the characteristics of the Reuleaux triangle to distribute positions of cleaning side brushes at a chassis of the sweeping robot, and at the same time further controls the movement of the sweeping robot, such that the sweeping robot can drive the cleaning side brushes to achieve a square cleaning trajectory (a square coverage can be achieved in a cleaning process), thus achieving the effects of cleaning corner areas and eliminating corner blind areas. It can be understood that to drive the cleaning side brushes to clean the corner areas, it is also necessary to control the movement trajectory of the sweeping robot. Referring to the flowchart of a method for controlling the movement of the sweeping robot shown in FIG. 3, positions of the cleaning side brushes at the bottom of the sweeping robot are distributed on the basis of the Reuleaux triangle, and the method mainly comprises the following steps S302-S304:

S302, if it is detected that the sweeping robot is currently in a corner environment, determining a central movement trajectory of the sweeping robot according to the corner environment, wherein the central movement trajectory of the sweeping robot is consistent with that of the Reuleaux triangle.

In a specific implementation, environmental information of the sweeping robot can be collected, and whether the environmental information contains corner features can be judged; if so, it is determined that the sweeping robot is currently in the corner environment. The corner environment includes a right-angled environment. It can be understood that a right-angled feature is a typical common corner feature in a home environment, and certainly it can also be other corners, such as angles greater than 90 degrees. In a practical application, the sweeping robot can be equipped with environmental sensors, such as a lidar, point cloud features of a surrounding environment can be extracted through the lidar, and an extraction result of the corner features by the lidar is taken as a judgment sign for entering corner environments such as the wall corner. After the sweeping robot is determined to be in the corner environment, the central movement trajectory of the sweeping robot (also the central movement trajectory of the Reuleaux triangle) can be determined based on the SLAM (Simultaneous Localization and Mapping) technology and the corner environment, thus guaranteeing the accuracy and reliability of cleaning the corner environment by the sweeping robot.

In this embodiment, the central movement trajectory of the sweeping robot described above, that is, the movement trajectory of a geometric center point of the sweeping robot, can also be called a revolution trajectory of a body. The central movement trajectory of the Reuleaux triangle is also the movement trajectory of a center point of the Reuleaux triangle.

S304, controlling the sweeping robot to move according to the central movement trajectory of the sweeping robot, and at the same time controlling the sweeping robot to rotate on its axis, such that the cleaning side brushes clean the corner environment. When the sweeping robot moves and rotates according to the central movement trajectory of the sweeping robot, a coverage of the cleaning side brushes in the sweeping process can be a square coverage. That is, the sweeping robot simultaneously performs revolution of the body (moving along a revolution trajectory of the body) and rotation of the body, the combination of which drives the cleaning side brushes to clean the corner environment, as long as the cleaning side brushes keep working during this period.

The above mode provided by the embodiment of the present disclosure can realize the effect that the circular sweeping robot can clean the corner environment such as the right-angled area by utilizing the trajectory characteristics of the Reuleaux triangle, which can effectively reduce the cleaning blind areas.

In order to ensure that the sweeping robot can move accurately according to its central movement trajectory, the real-time movement state of the sweeping robot can be detected; trajectory tracking control is performed on the sweeping robot according to the real-time movement state and the central movement trajectory of the sweeping robot, so as to ensure that the sweeping robot moves according to the central movement trajectory of the sweeping robot, and guarantee the accuracy and reliability of corner area cleaning by the sweeping robot according to the trajectory. In a practical application, the sweeping robot can be equipped with a detection feedback module, such as an IMU (Inertial Measurement Unit) inertial navigation system, an odometer, a motor current sensor and a drop/collision sensor, which are configured to detect the real-time movement state of the sweeping robot; and a controller of the sweeping robot performs trajectory closed-loop control according to the detected real-time movement state, so as to realize trajectory anti-interference tracking, and ensure the accuracy of the movement of the sweeping robot according to the established trajectory.

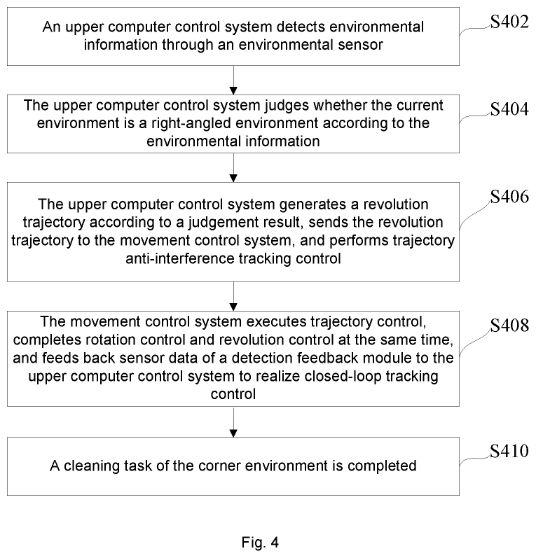

For ease of understanding, the embodiment provides a specific implementation for the sweeping robot to implement the above method. The sweeping robot mainly comprises an upper computer control system and a lower computer control system (also called a movement control system), wherein the lower computer control system is responsible for signal acquisition and bottom movement control of a robot sensor (configured to detect a movement state of the sweeping robot), and the upper computer control system performs environmental perception and path planning according to sensor information; specifically, the lower computer control system can preprocess signals collected by the sensor, and then transmit the signals to the upper computer control system through a communication interface, and the upper computer control system performs mapping and decision making based on the received signals, and specifically makes a movement plan according to pre-designed task instructions and the received sensor information and detects the movement state detected by the sensor during the movement of the sweeping robot, thus forming closed-loop control. Specifically, the sweeping robot can refer to steps S402-S410 as shown in FIG. 4:

S402: the upper computer control system detects the environmental information through the environmental sensor. For example, the point cloud features of the surrounding environment can be extracted according to the lidar.

S404: the upper computer control system judges whether the current environment is a right-angled environment according to the environmental information. It can be understood that a radar can obtain outline information of obstacles, which consists of a series of points, including distances and angles, so it can be judged whether it is a right angle or not, and right-angle side distances can also be detected.

S406: the upper computer control system generates a revolution trajectory according to a judgment result, sends the revolution trajectory to the movement control system, and performs trajectory anti-interference tracking control. The revolution trajectory is the movement trajectory of the center of the body and also the movement trajectory of the center point of the Reuleaux triangle of the robot chassis. In a specific implementation, the movement trajectory can be converted into parameters such as the magnitude of velocity and the magnitude of angle of the robot to be sent to the movement control module, such that the movement control module can move according to the received parameters, and the trajectory made conforms to the movement trajectory of the center of the body.

S408: the movement control system executes trajectory control, completes rotation control and revolution control at the same time, and feeds back sensor data of a detection feedback module to the upper computer control system to realize closed-loop tracking control. Where, the detection feedback module mainly detects the movement control system and can include parameters such as motor current, a rotation speed and a rotation angle.

S410: a cleaning task of the corner environment is completed.

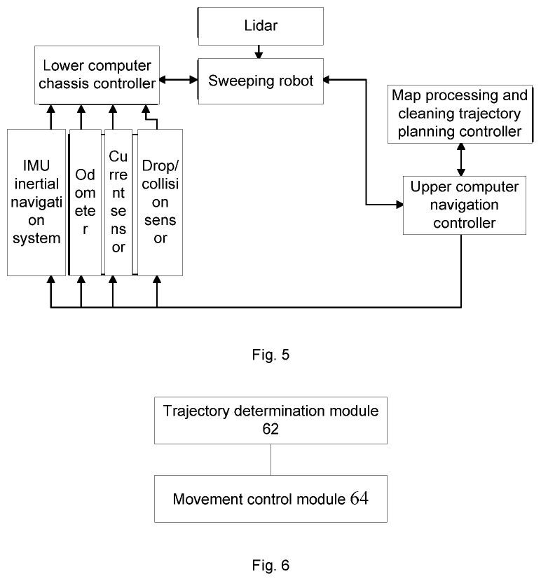

In a specific implementation, this embodiment further provides a schematic diagram illustrating a main structure of a sweeping robot as shown in FIG. 5, showing that the sweeping robot is equipped with a laser radar, a lower computer chassis controller, a map processing and cleaning trajectory planning controller, an upper computer navigation controller, and an IMU inertial navigation system, an odometer, a current sensor (specifically a motor current sensor) and a drop/collision sensor that are connected with the lower computer chassis controller. Respective functions of the above controllers and sensors correspond to the above-mentioned upper computer control system and lower computer control system, which will not be repeated here.

To sum up, the method for controlling the movement of the sweeping robot provided in this embodiment provides a theoretical basis for the layout design of the cleaning side brushes on the basis of the principle of the Reuleaux triangle. At the same time, the sweeping robot simultaneously performs the revolution of the body (the movement trajectory of a geometric center of the sweeping robot, also called the movement trajectory of a center point of Reuleaux triangle) and the rotation of the body, the combination of which can envelop a square sweeping track, so as to drive the cleaning side brushes to clean the corner environment such as the right-angled area, thereby effectively reducing the cleaning blind areas. At the same time, through the closed-loop trajectory tracking control, the reliability of corner environment cleaning by the sweeping robot according to the established trajectory can be further ensured.

Corresponding to the aforementioned method for controlling the movement of the sweeping robot, this embodiment further provides a structural block diagram of an apparatus for controlling the movement of the sweeping robot as shown in FIG. 6, in which at least one position of at least one cleaning side brush at a bottom of the sweeping robot is distributed on the basis of the Reuleaux triangle, the apparatus mainly comprising:
a trajectory determination module 62 is configured to determine a central movement trajectory of the sweeping robot according to a corner environment if it is detected that the sweeping robot is currently in the corner environment, wherein the central movement trajectory of the sweeping robot is consistent with that of the Reuleaux triangle; and
a movement control module 64 is configured to control the sweeping robot to move according to the central movement trajectory of the sweeping robot, and at the same time control the sweeping robot to rotate on its axis, such that the cleaning side brushes clean the corner environment.

The above apparatus provided by the embodiment of the present disclosure can realize the effect that the circular sweeping robot can clean the corner environment such as the right-angled area by utilizing the trajectory characteristics of the Reuleaux triangle, which can effectively reduce the cleaning blind areas.

In an implementation, the number of the cleaning side brush is one, two or three, and each cleaning side brush is arranged at a vertex of the Reuleaux triangle.

In an implementation, the apparatus described above further comprises a corner judging module, which is configured to: collect environmental information of the sweeping robot and judge whether the environmental information contains a corner feature; if so, determine that the sweeping robot is currently in the corner environment.

In an implementation, the trajectory determination module 62 is further configured to determine the central movement trajectory of the sweeping robot based on the SLAM technology and the corner environment.

In an implementation, the movement control module 64 is further configured to detect a real-time movement state of the sweeping robot; perform trajectory tracking control on the sweeping robot according to the real-time movement state and the central movement trajectory of the sweeping robot, so as to ensure that the sweeping robot moves according to the central movement trajectory of the sweeping robot.

In an implementation, the corner environment includes a right-angled environment.

In an implementation, when the sweeping robot moves and rotates according to the central movement trajectory of the sweeping robot, a coverage of the cleaning side brushes in the sweeping process is a square coverage.

The implementation principle and generated technical effect of the apparatus provided by this embodiment are the same as those of the previous embodiment. For the sake of brevity, where no mention is made in the apparatus embodiments, reference may be made to the corresponding matters in the method embodiments described above.

An embodiment of the present disclosure provides a sweeping robot, in which positions of cleaning side brushes at a bottom of the sweeping robot are distributed on the basis of a Reuleaux triangle, the sweeping robot comprising: a processor and a storage apparatus,
wherein the storage apparatus has stored thereon a computer program, which, when run by the processor, executes the method for controlling the movement of the sweeping robot as described above.

An embodiment of the present disclosure provides a storage medium having stored thereon a computer program, which, when run by the processor, executes the steps of the movement control method of the sweeping robot described above.

It can be understood that the same or similar parts in the above-mentioned embodiments can refer to each other, and the contents not explained in detail in some embodiments can refer to the same or similar contents in other embodiments.

It should be noted that in the description of the present disclosure, the terms “first” and “second” are only used for descriptive purposes, and are not to be construed as indicating or implying relative importance. In addition, in the description of the present disclosure, the meaning of “a plurality of”, “plural” means at least two unless otherwise specified.

It will be understood that when an element is referred to as being “fixed to” or “disposed to” another element, it can be directly on the other element or an intervening element may also be present; when an element is referred to as being “connected” to another element, it can be directly connected to the other element or an intervening element may also be present, and further, as used herein, “connected” may include wirelessly connected; the used term “and/or” is used to include any and all combinations of one or more of the associated listed items.

Any process or method descriptions in the flowcharts or otherwise described herein may be understood as: representing a modules, a segment, or a portion of a code which includes one or more executable instructions configured to implement steps of a particular logical function or process, and the scope of the preferred implementation of the present disclosure includes additional implementations in which functions may be executed out of order from that shown or discussed, including substantially concurrently or in reverse order, depending on the functionality involved, as would be understood by those skilled in the art to which the embodiments of the present disclosure belong.

It should be understood that various parts of the present disclosure can be implemented by hardware, software, firmware or a combination thereof. In the implementation described above, a plurality of steps or methods can be implemented by software or firmware that is stored in a memory and executed by a suitable instruction execution system. For example, if implemented in hardware, as in another implementation, they can be implemented by any one or combination of the following technologies well known in the art: a discrete logic circuit having a logic gate circuit configured to implement a logic function on a data signal, an application specific integrated circuit having an appropriate combinational logic gate circuit, a Programmable Gate Array (PGA), a field Programmable Gate Array (FPGA), or the like.

It will be understood by those of ordinary skill in the art that all or part of the steps carried in the method of implementing the above embodiments may be implemented by instructing related hardware through a program, which may be stored in a computer-readable storage medium, and the program, when executed, includes one or a combination of the steps of the method embodiments.

In addition, functional units in the embodiments of the present disclosure may be integrated into one processing module, or each unit may exist alone physically, or two or more units are integrated into one module. The above-mentioned integrated module can be implemented in the form of hardware or software functional modules. If the integrated module is implemented in the form of a software functional module and sold or used as an independent product, it can also be stored in a computer readable storage medium.

The storage medium mentioned above can be a read-only memory, a magnetic disk or an optical disk, etc.

In the description of this specification, the description referring to the terms “one embodiment”, “some embodiments”, “examples”, “specific examples” or “some examples” means that the specific features, structures, materials or characteristics described in connection with this embodiment or example are included in at least one embodiment or example of the present disclosure. In this specification, the schematic expressions of the terms used above do not necessarily refer to the same embodiment or example. Furthermore, the specific features, structures, materials or characteristics described may be combined in any one or more embodiments or examples in a suitable manner.

Although the embodiments of the present disclosure have been shown and described above, it can be understood that the above embodiments are illustrative and should not be construed as limitations of the present disclosure, and variations, modifications, substitutions, and alterations of the above-described embodiments may occur to those of ordinary skill in the art and are intended to be within the scope of the present disclosure.

What is claimed is:

1. A method for controlling movement of a sweeping robot, in which at least one position of at least one cleaning side brush at a bottom of the sweeping robot is distributed on the basis of a Reuleaux triangle, the method comprising:
in case that the sweeping robot is detected currently in a corner environment, determining a central movement trajectory of the sweeping robot according to the corner environment, wherein the central movement trajectory of the sweeping robot is consistent with that of the Reuleaux triangle; and
controlling the sweeping robot to move according to the central movement trajectory of the sweeping robot, and at the same time controlling the sweeping robot to rotate on its axis to use the cleaning side brushes clean the corner environment.

2. The method according to claim 1, wherein the number of the cleaning side brushes is one, two or three, and each of the cleaning side brush is arranged at a vertex of the Reuleaux triangle.

3. The method according to claim 1, wherein the method further comprises:
collecting environmental information of the sweeping robot, and judging whether the environmental information contains corner features;
in case that the environmental information contains corner features, determining that the sweeping robot is currently in the corner environment.

4. The method according to claim 1, wherein the step of determining the central movement trajectory of the sweeping robot according to the corner environment comprises:
based on a SLAM technology and the corner environment, determining the central movement trajectory of the sweeping robot.

5. The method according to claim 1, wherein the step of controlling the sweeping robot to move according to the central movement trajectory of the sweeping robot comprises:
detecting a real-time movement state of the sweeping robot; performing trajectory tracking control on the sweeping robot according to the real-time movement state and the central movement trajectory of the sweeping robot, to ensure that the sweeping robot moves according to the central movement trajectory of the sweeping robot.

6. The method according to claim 1, wherein the corner environment comprises a right-angled environment.

7. The method according to claim 6, wherein when the sweeping robot moves according to the central movement trajectory of the sweeping robot and rotates on its axis, a coverage of the cleaning side brushes in a sweeping process is a square coverage.

8. (canceled)

9. A sweeping robot, in which at least one position of at least one cleaning side brush at a bottom of the sweeping robot is distributed on the basis of a Reuleaux triangle, the sweeping robot comprising: a processor and a storage apparatus,
wherein the storage apparatus has stored thereon a computer program, which, when run by the processor, executes a method for controlling movement of the sweeping robot, wherein the method comprises:
in a case that the sweeping robot is detected currently in a corner environment, determining a central movement trajectory of the sweeping robot according to the corner environment, wherein the central movement trajectory of the sweeping robot is consistent with that of the Reuleaux triangle; and
controlling the sweeping robot to move according to the central movement trajectory of the sweeping robot, and at the same time controlling the sweeping robot to rotate on its axis to use the cleaning side brushes clean the corner environment.

10. A non-transitory computer-readable storage medium having stored thereon a computer program, which, when run by a processor, executes a method for controlling movement of a sweeping robot, wherein the method comprises:
in a case that the sweeping robot is detected currently in a corner environment, determining a central movement trajectory of the sweeping robot according to the corner environment, wherein the central movement trajectory of the sweeping robot is consistent with that of the Reuleaux triangle; and
controlling the sweeping robot to move according to the central movement trajectory of the sweeping robot, and at the same time controlling the sweeping robot to rotate on its axis to use the cleaning side brushes clean the corner environment.

11. The method according to claim 9, wherein the number of the cleaning side brush is one, two or three, and each of the cleaning side brush is arranged at a vertex of the Reuleaux triangle.

12. The method according to claim 9, wherein the method further comprises:
collecting environmental information of the sweeping robot, and judging whether the environmental information contains a corner feature;
in case that the environmental information contains the corner feature, determining that the sweeping robot is currently in the corner environment.

13. The method according to claim 9, wherein the step of determining the central movement trajectory of the sweeping robot according to the corner environment comprises:
based on a SLAM technology and the corner environment, determining the central movement trajectory of the sweeping robot.

14. The method according to claim 9, wherein the step of controlling the sweeping robot to move according to the central movement trajectory of the sweeping robot comprises:
detecting a real-time movement state of the sweeping robot; performing trajectory tracking control on the sweeping robot according to the real-time movement state and the central movement trajectory of the sweeping robot, to ensure that the sweeping robot moves according to the central movement trajectory of the sweeping robot.

15. The method according to claim 9, wherein the corner environment comprises a right-angled environment.

16. The method according to claim 15, wherein when the sweeping robot moves according to the central movement trajectory of the sweeping robot and rotates on its axis, a coverage of the cleaning side brush in a sweeping process is a square coverage.

17. The method according to claim 10, wherein the number of the cleaning side brush is one, two or three, and each of the cleaning side brush is arranged at a vertex of the Reuleaux triangle.

18. The method according to claim 10, wherein the method further comprises:
collecting environmental information of the sweeping robot, and judging whether the environmental information contains a corner feature;
in case that the environmental information contains the corner feature, determining that the sweeping robot is currently in the corner environment.

19. The method according to claim 10, wherein the step of determining the central movement trajectory of the sweeping robot according to the corner environment comprises:
based on a SLAM technology and the corner environment, determining the central movement trajectory of the sweeping robot.

20. The method according to claim 10, wherein the step of controlling the sweeping robot to move according to the central movement trajectory of the sweeping robot comprises:
detecting a real-time movement state of the sweeping robot; performing trajectory tracking control on the sweeping robot according to the real-time movement state and the central movement trajectory of the sweeping robot, to ensure that the sweeping robot moves according to the central movement trajectory of the sweeping robot.
